(19) United States
(12) Patent Application Publication
(10) Pub. No.: US 2012/0246167 A1
(43) Pub. Date: Sep. 27, 2012

(54) Reducing Bookmark File Search Time

(75) Inventor: Michael Alexander, Denver, CO (US)

(73) Assignee: EchoStar Technologies L.L.C., Englewood, CO (US)

(21) Appl. No.: 13/071,179

(22) Filed: Mar. 24, 2011

(51) Int. Cl. G06F 17/30; G06F 7/00

(52) U.S. Cl. 707/741; 707/736; 707/E17.014

(57) ABSTRACT

A player utilizes a bookmark file to process content. The bookmark file includes a sequential series of bookmarks that each include information specifying how to process content. In one or more implementations, only some bookmarks are indicated as searchable. When the player searches for a particular bookmark, it only searches bookmarks indicated as searchable. In various other implementations, the player utilizes an index to search for a particular bookmark. In some cases, the index contains an entry for each bookmark in the bookmark file that includes only the type and location of the respective bookmark. In other cases, only some of the bookmarks may be indicated as searchable and the index may only include entries for the searchable bookmarks. However, in these cases, the index may not include entries for bookmarks indicated as non-searchable. In either set of cases, the index may be updated if the bookmark file changes.

### FIELD OF THE INVENTION

This disclosure relates generally to received content, and more specifically to reducing search time of bookmark files that are utilized to process received content.

### SUMMARY

The present disclosure discloses systems and methods for reducing search time of bookmark files that are utilized to process received content. A content player may utilize a bookmark file to process content. The bookmark file may include a sequential series of bookmarks that each include information specifying how to process content.

In one or more implementations, only a portion of the bookmarks may include indications that the respective bookmark is searchable. Searchable bookmarks may include the location of one or more previous and/or subsequent bookmarks in the bookmark file. When the content player searches for one or more particular bookmarks in the bookmark file, the content player may reduce search time by only searching the bookmarks that are indicated as searchable.

In various other implementations, the content player may utilize one or more indexes to search for one or more particular bookmarks in one or more bookmark files. In some cases, the index may include an entry for each bookmark in the bookmark file. Each entry in the index may include the type of the respective bookmark and the location of the respective bookmark in the bookmark file. Such entries may not include other information contained in the bookmark that is related processing the content. If the bookmark file is subsequently changed, the index may be updated to reflect the changes to the bookmark file. When the content player searches for one or more particular bookmarks, the content player may search the index instead of the bookmark file.

In some instances of these various other implementations, some of the bookmarks in the bookmark file may be indicated as searchable whereas other bookmarks in the bookmark file are indicated as non-searchable. In such cases, the index may include entries for the bookmarks indicated as searchable. However, in these cases, the index may not include entries for bookmarks indicated as non-searchable.

It is to be understood that both the foregoing general description and the following detailed description are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

FIG. 1 is a block diagram illustrating a system for reducing search time of bookmark files that are utilized to process received content.

FIG. 2 is a flow chart illustrating a first example method for reducing search time of bookmark files that are utilized to process received content. This method may be performed by the system of FIG. 1.

FIG. 3 is a flow chart illustrating a second example method for reducing search time of bookmark files that are utilized to process received content. This method may be performed by the system of FIG. 1.

FIG. 4A is a conceptual diagram illustrating a first example bookmark file that may be utilized to process received content.

FIG. 4B is a conceptual diagram illustrating an index that may be generated for the first example bookmark file of FIG. 4A.

FIG. 5A is a conceptual diagram illustrating a second example bookmark file, which includes one or more bookmarks that are designated as searchable and one or more bookmarks that are designated as non-searchable, that may be utilized to process received content.

FIG. 5B is a conceptual diagram illustrating an index that may be generated for the second example bookmark file of FIG. 5A.

### DETAILED DESCRIPTION OF THE EMBODIMENTS

The description that follows includes sample systems, methods, and computer program products that embody various elements of the present disclosure. However, it should be understood that the described disclosure may be practiced in a variety of forms in addition to those described herein.

A content receiver and/or player (such as a television receiver, set top box, a digital video recorder, a digital video player, a digital music player, a personal computer, a cellular telephone, a tablet computer, a mobile computer, and so on) may construct one or more files referred to as a “bookmark file” as multi-stream content (such as audio, video, and/or data content) is received and/or recorded utilizing metadata included with, and/or corresponding to, the content. The bookmark file may include a sequential series of one or more “bookmarks” that each contain information on how to process the received/stored content as well as time and/or other references to the portion of the received/stored content to which the information relates. Such bookmarks may include bookmarks indicating the start of an event that is included in the received/stored content, bookmarks indicating what portions of the received/stored content include video and/or audio for an event, bookmarks indicating other content to play before returning to play more of the received/stored content, as well as may other types of bookmarks regarding various aspects of how to process the received/stored content. When the received/stored content is played, the bookmarks in the bookmark file may be sequentially processed as the content is parsed such that actions involved in playing a particular portion of the received/stored content as specified in a corresponding bookmark are performed, though the bookmark file may not include bookmarks that contain information on how to process every portion of the received/stored content. As such, one or more bookmark files that correspond to received/stored content may be required in order to process such received/stored content.

In some instances, a content receiver may need to locate one or more particular bookmarks in a bookmark file. For example, when a user records received multi-stream content, the user may have started recording prior to the start of an event (such as a television program). Hence, the start of the recorded content may not be the start of the event. The user may instruct the content receiver to play the recorded content from the point where the event starts. In response, the content receiver may linearly search through bookmarks in one or more bookmark files corresponding to the recorded content to locate one or more bookmarks that indicate the start of the event. Once the content receiver has located the bookmark that indicates the start of the event, the content receiver may utilize the located bookmark to begin playing the recorded content from the point where the event starts. Additionally, as the recorded content included multiple streams, once the bookmark indicating the start of the event is located the content receiver may also need to locate a previous bookmark in the bookmark file that specifies that portions of the recorded content that correspond to audio and video at the portion of the recorded content corresponding to the start of the event in order to be able to play the content.

However, as these sort of bookmark files include more and more bookmarks, corresponding to a myriad of possible different activities that may be performed in processing received content, the time needed to search for particular bookmarks may increase. Increased search time for particular bookmarks may cause content receiver and/or player activities that utilize such searches to also require more time. As a result, content receivers and/or players may not be as responsive to user instructions and may not be able to perform functions related to such user instructions without delays of a duration that users may find unacceptable or annoying.

The present disclosure discloses systems and methods for reducing search time of bookmark files that are utilized to process received content. A content player may generate one or more bookmark files utilizing metadata corresponding to and/or included with multi-stream content that is received and/or may receive such a bookmark file as well as such content. The bookmark file may include a sequential series of bookmarks that each include information that the content player may utilize to process the received content.

In one or more implementations, one or more bookmarks of the bookmark file may include an indication that the respective bookmark is searchable whereas one or more other bookmarks of the bookmark file may include an indication that the respective bookmark is not searchable. Bookmarks that include an indication that the respective bookmark is searchable may include the location of one or more previous and/or subsequent bookmarks in the bookmark file, such as locations of the next bookmark in the bookmark file, the next bookmark of the same type in the bookmark file, and other such previous and/or subsequent bookmarks. When the content player searches for one or more particular bookmarks in the bookmark file, the content player may search the bookmarks that are indicated as searchable and omit searching the bookmarks that are not indicated as searchable, thus reducing the total amount of time necessary to search for the one or more particular bookmarks as compared to searching all of the bookmarks in the bookmark file.

In various implementations, the content player may generate one or more indexes for the bookmark file and/or may receive such an index. The index may include an entry for each bookmark that includes the type of the respective bookmark and the location of the respective bookmark in the bookmark file, but not the information contained in the bookmark for processing the received content. Such an index file may be generated when the bookmark file is generated and/or may be generated subsequent to the generation of the bookmark file. If the bookmark file is changed after the index is generated, the index may be updated to reflect the changes to the bookmark file. When the content player searches for one or more particular bookmarks, the content player may search the index instead of the bookmark file. As the index does not include the full amount of information present in the bookmark file, the total amount of time necessary to search for the one or more particular bookmarks is reduced as compared to searching the entire bookmark file. If some of the bookmarks in the bookmark file are indicated as searchable whereas other bookmarks in the bookmark file are indicated as non-searchable, the index may include entries for the bookmarks indicated as searchable but may not include entries for bookmarks indicated as non-searchable. In this way, search time for one or more particular bookmarks may be even further reduced.

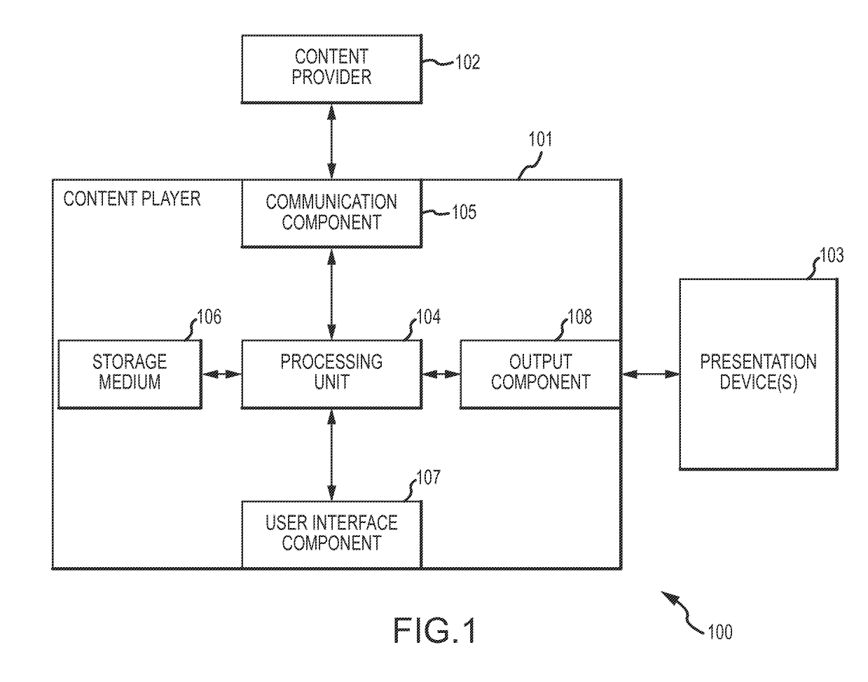

FIG. 1 is a block diagram illustrating a system 100 for reducing search time of bookmark files that are utilized to process received content. The system 100 includes a content player 101, which may also be a content receiver. The content player may be any kind of content player such as a television receiver, set top box, a digital video recorder, a digital video player, a digital music player, a personal computer, a cellular telephone, a tablet computer, a mobile computer, and/or other electronic device suitable to play content (such as audio content, video content, television programming, on-demand programming, pay-per-view movies, and/or other such content).

The content player 101 may include one or more processing units 104, one or more communication components 105, one or more non-transitory storage media 106 (which may take the form of, but is not limited to, a magnetic storage medium; optical storage medium; magneto-optical storage medium; read only memory; random access memory; erasable programmable memory; flash memory; and so on), one or more user interface components (which may receive one or more user inputs via one or more user input devices such as one or more remote control devices), and one or more output components 108. The system 100 may also include one or more presentation devices 103 (such as one or more televisions, computer monitors, liquid crystal displays, cathode ray tube displays, plasma screen displays, speakers, and/or other kind of presentation devices) and the processing unit may execute instructions stored in the non-transitory storage medium 106 to process multi-stream content that is received from one or more content providers 102 (which may be any kind of content provider such as a satellite and/or cable television programming provider, an on-demand video provider, a pay-per-view content provider, a digital music subscription service, and so on) via the communication component 105 and/or is stored in the non-transitory storage medium and present such processed content to the presentation device 107 via the output component 108.

The content player 101 may utilize one or more bookmark files to process the content. The bookmark file, which may be stored in the non-transitory storage medium 106, may include a sequential series of bookmarks that each include information which the content player utilizes to process the content as well as time and/or other references to the portion of the content to which the information relates. Such bookmarks may include bookmarks indicating the start of an event that is included in the content, bookmarks indicating what portions of the content include video and/or audio for an event, bookmarks indicating other content to play before returning to play more of the content, as well as may other types of bookmarks regarding various aspects of how to process the content. When the content player processes the content, the content player may sequentially process the bookmarks in the bookmark file as the content is parsed such that the content player performs actions involved in processing a particular portion of the content as specified in a corresponding bookmark, though the bookmark file may not include bookmarks that contain information on how to process every portion of the content. The bookmark file may be generated utilizing metadata included with and/or corresponding to the content and may be generated by the content player when the content is received and/or may itself be received by the content player.

In one or more first sample implementations, one or more indexes for the bookmark file may be generated and may be stored in the non-transitory storage medium 106. The content player 101 may generate such an index and/or may receive the index after it has been generated. The index may include an entry for each bookmark that includes the type of the respective bookmark and the location of the respective bookmark in the bookmark file. However, the entries may not include the information contained in the respective bookmark for processing the content. Such an index file may be generated when the bookmark file is generated and/or may be generated subsequent to the generation of the bookmark file. If the bookmark file is changed after the index is generated, the index may be updated to reflect the changes to the bookmark file.

When the content player 101 searches for one or more particular bookmarks, the content player may search the index based on the type indicated by the entries in the index. When the content player locates an entry in the index that has a type matching the searched particular bookmark, the content player may examine the location in the bookmark file included in the entry to evaluate whether or not the entry corresponds to the particular bookmark for which the content player is searching. If the entry does not correspond to the searched for particular bookmark, the content player may continue searching the index for the next entry that matches the type of the searched for particular bookmark.

In some versions of these first sample implementations, some of the bookmarks in the bookmark file may include an indication that they are searchable whereas other bookmarks in the bookmark file may not include such an indication and/or may include an indication that they are not searchable. If so, the index file may include entries for the bookmarks that include a searchable indication but may not include entries for the bookmarks that do not include such a searchable indication.

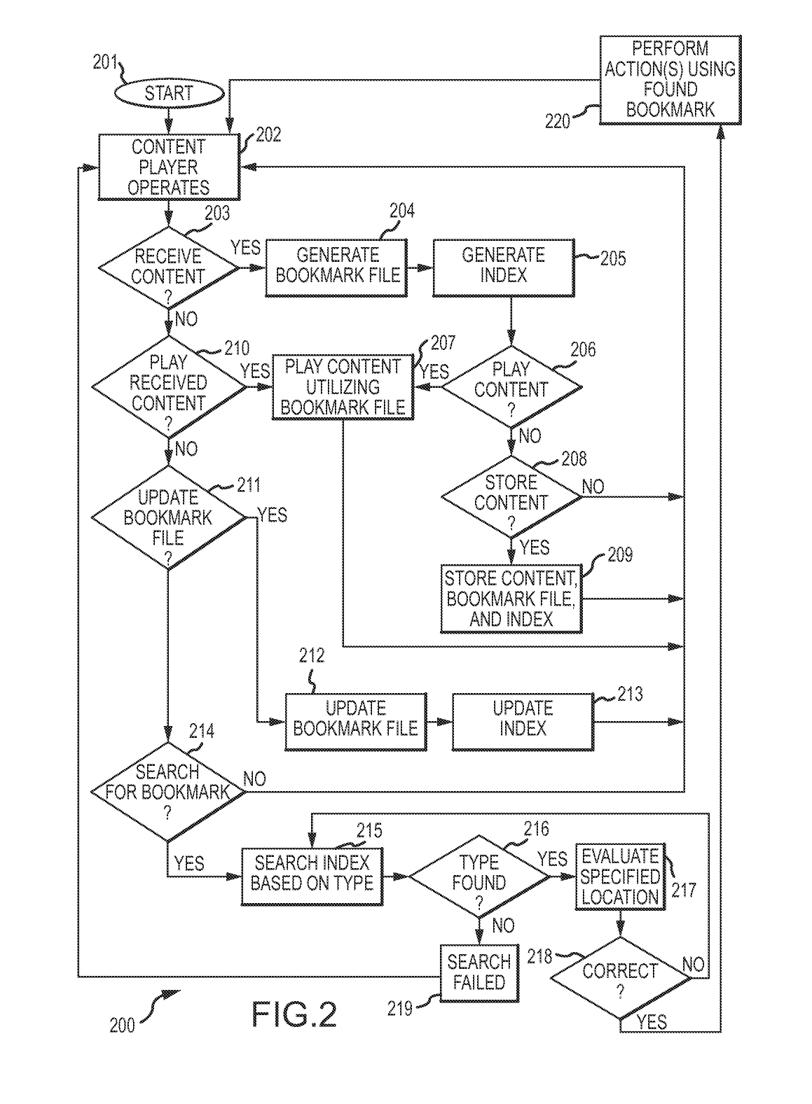

FIG. 2 illustrates a first sample method 200 for reducing search time of bookmark files that are utilized to process received content. The first sample method 200 may be performed by the content player 101 of FIG. 1. The flow begins at block 201 and proceeds to block 202 where the content player operates. The flow then proceeds to block 203 where the content player determines whether or not content is received. If so, the flow proceeds to block 204. Otherwise, the flow proceeds to block 210.

At block 204, after the content player 101 determines that content has been received, the content player generates a bookmark file for the received content and the flow proceeds to block 205. At block 205, the content player generates an index for the bookmark file. Next, the flow proceeds to block 206 where the content player determines whether or not to play the received content. If so, the flow proceeds to block 207 where the content player plays the received content utilizing the bookmark file before the flow returns to block 202 and the content player continues to operate. Otherwise, the flow proceeds to block 208 where the content receiver determines whether or not to store the received content. If not, the flow returns to block 202 and the content player continues to operate. Otherwise, the flow proceeds to block 209 and the content player stores the received content in the non-transitory storage medium 106 before the flow returns to block 202 and the content player continues to operate.

At block 210, after the content player 101 determines that content has not been received, the content player determines whether or not to play content stored in the non-transitory storage medium 106. If so, the flow proceeds to block 207 where the content player plays the received content utilizing the bookmark file before the flow returns to block 202 and the content player continues to operate.

Otherwise, the flow proceeds to block 211 where the content player 101 determines whether or not to update one or more bookmark files. If so, the flow proceeds to block 212. Otherwise, the flow proceeds to block 214.

At block 212, after the content player 101 determines to update one or more bookmark files, the content player updates the one or more bookmark files and the flow proceeds to block 213. At block 213, the content player updates one or more indexes for the one or more updated bookmark files. The flow then returns to block 202 and the content player continues to operate.

At block 214, after the content player 101 determines to update one or more bookmark files, the content player determines to search for one or more particular bookmarks in one or more particular bookmark files. If not, the flow then returns to block 202 and the content player continues to operate. Otherwise, the flow proceeds to block 215. It should be understood that although this operation is illustrated as separate from block 207, the content player may search for one or more particular bookmarks in one or more bookmark files as part of the operations performed at block 207.

At block 215, after the content player 101 determines to search for one or more particular bookmarks in one or more bookmark files, the content player searches one or more indexes for the one or more bookmark files based on a type of the one or more particular bookmarks. The flow then proceeds to block 216 where the content player determines whether an entry of the type searched is found in the one or more indexes. If not, the content player determines that the search has failed and handles such search failure (such as by presenting one or more error messages that an activity related to the search cannot be performed) before the flow returns to block 202 and the content player continues to operate.

Otherwise, the content player 101 evaluates the bookmark at the location in the one or more bookmark files included in the entry in the one or more indexes. The flow then proceeds to block 218 where the content player determines whether or not the one or more bookmarks are the correct one or more bookmarks for which the content player is searching. If not, the flow returns to block 215 and the content player continues to search the one or more indexes for the one or more bookmark files based on the type of the one or more particular bookmarks. Otherwise, the flow proceeds to block 210 where the content player performs one or more actions related to the search utilizing the one or more found bookmarks. The flow then returns to block 202 and the content player continues to operate.

Returning to FIG. 1, in one or more second sample implementations, the content player 101 may not utilize an index to search the bookmark file. Instead, some of the bookmarks of the bookmark file may include an indication that the respective bookmark is searchable whereas other bookmarks do not. In such second sample implementations the content player may search for one or more particular bookmarks in the bookmark by searching the bookmarks that are indicated as searchable and skipping the bookmarks that are not indicated as searchable and/or are indicated as non-searchable. The bookmarks in the bookmark file may be marked as searchable or non-searchable at the time the bookmark file is created and/or the content player may mark bookmarks as searchable or non-searchable after the bookmark file is created.

In such second example implementations, bookmarks that are marked as searchable may include the location of one or more previous and/or subsequent bookmarks in the bookmark file. Such previous and/or subsequent bookmarks may be the next bookmark in the bookmark file, the next bookmark of the same type in the bookmark file, and other such previous and/or subsequent bookmarks. For example, bookmarks indicating the start of an event in the content may include a location of the next bookmark in the bookmark file, a location of the next event start bookmark in the bookmark file, and/or the previous bookmark that indicates what portions of the content at a particular point in the content include video and/or audio for an event. By including locations of a variety of different bookmarks in the bookmark file with a particular bookmark, efficient performance of a variety of different kinds of searches may be enabled.

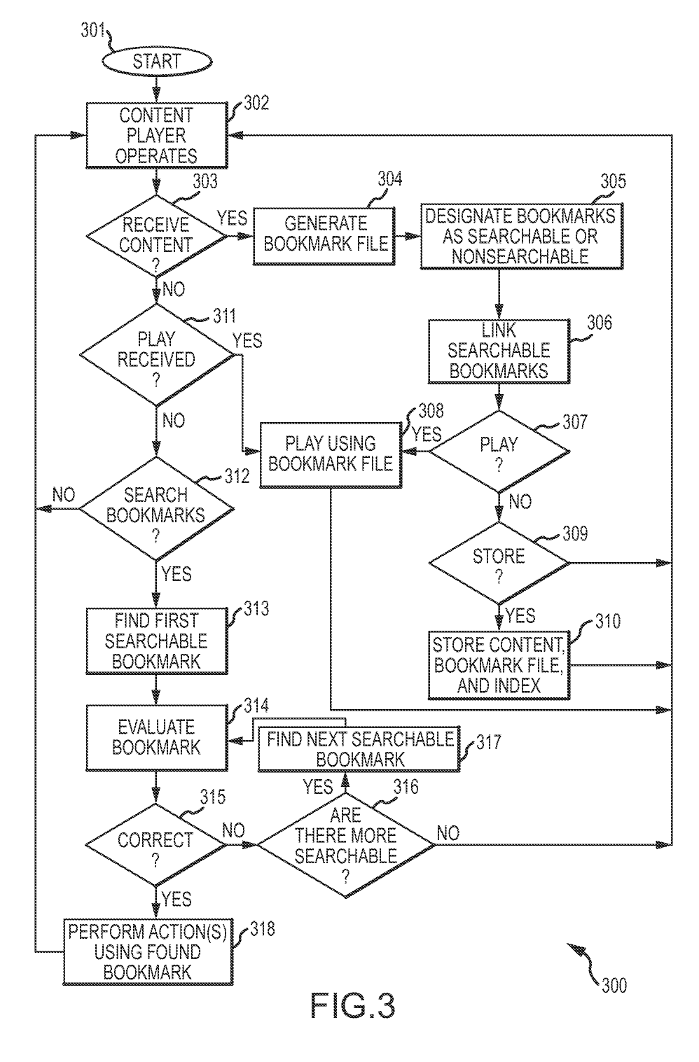

FIG. 3 illustrates a second sample method 300 for reducing search time of bookmark files that are utilized to process received content. The second sample method 300 may be performed by the content player 101 of FIG. 1. The flow begins at block 301 and proceeds to block 302 where the content player operates. The flow then proceeds to block 303 where the content player determines whether or not content is received. If so, the flow proceeds to block 304. Otherwise, the flow proceeds to block 311.

At block 304, after the content player 101 determines that content has been received, the content player generates a bookmark file for the received content and the flow proceeds to block 305. At block 305, the content player designates one or more of the bookmarks in the bookmark file as searchable or non-searchable. Next, the flow proceeds to block 306 where the content player adds links from one or more of the bookmarks indicated as searchable to one or more other bookmarks indicated as searchable.

The flow then proceeds to block 307 where the content player 101 determines whether or not to play the received content. If so, the flow proceeds to block 308 where the content player plays the received content utilizing the bookmark file before the flow returns to block 302 and the content player continues to operate. Otherwise, the flow proceeds to block 309 where the content receiver determines whether or not to store the received content. If not, the flow returns to block 302 and the content player continues to operate. Otherwise, the flow proceeds to block 310 and the content player stores the received content in the non-transitory storage medium 106 before the flow returns to block 302 and the content player continues to operate.

At block 311, after the content player 101 determines that content has not been received, the content player determines whether or not to play content stored in the non-transitory storage medium 106. If so, the flow proceeds to block 308 where the content player plays the received content utilizing the bookmark file before the flow returns to block 302 and the content player continues to operate. Otherwise, the flow proceeds to block 312 where the content player determines whether or not to search for one or more particular bookmarks in one or more particular bookmark files. If not, the flow then returns to block 302 and the content player continues to operate. Otherwise, the flow proceeds to block 313. It should be understood that although this operation is illustrated as separate from block 308, the content player may search for one or more particular bookmarks in one or more bookmark files as part of the operations performed at block 308.

At block 313, the content player 101 locates the first bookmark in the one or more bookmark files that is located as searchable. The flow then proceeds to block 314 where the content player evaluates the bookmark. Next, the flow proceeds to block 315 where the content player determines whether or not the bookmark is the correct bookmark for which the content player is searching. If so, the flow proceeds to block 318 where the content player performs one or more actions related to the search utilizing the one or more found bookmarks. The flow then returns to block 302 and the content player continues to operate.

Otherwise, the flow proceeds to block 316 where the content player 101 determines whether or not the one or more bookmark files contain one or more searchable bookmarks. If not, the content player determines that the search has failed and handles such search failure (such as by presenting one or more error messages that an activity related to the search cannot be performed) before the flow returns to block 302 and the content player continues to operate. Otherwise, the flow proceeds to block 317 and the content player searches for the next searchable bookmark in the one or more bookmark files.

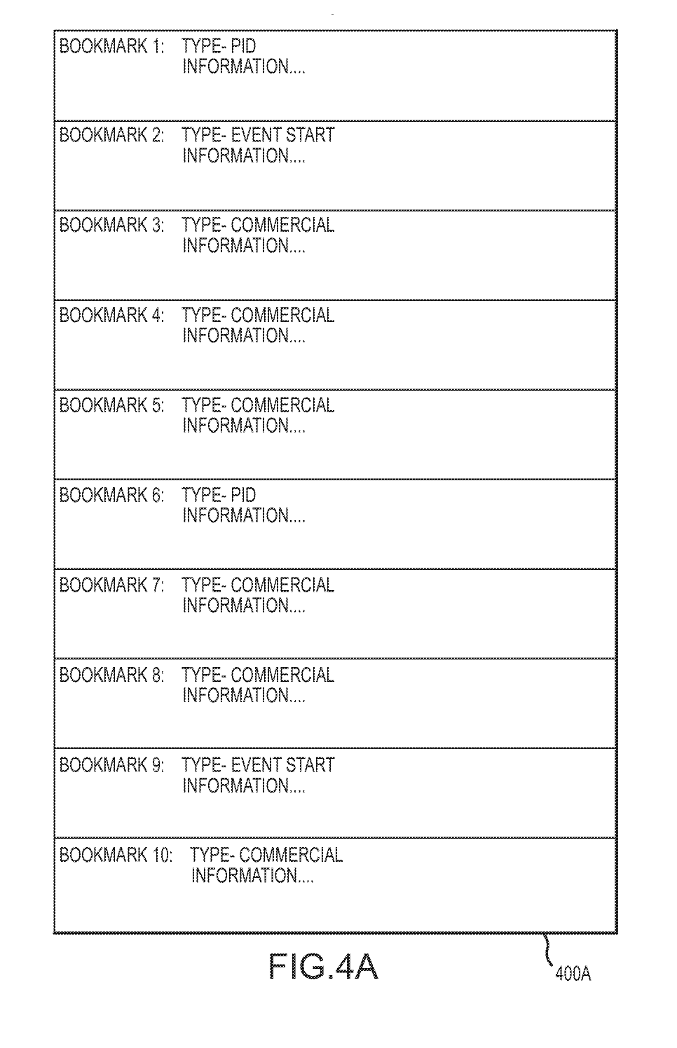

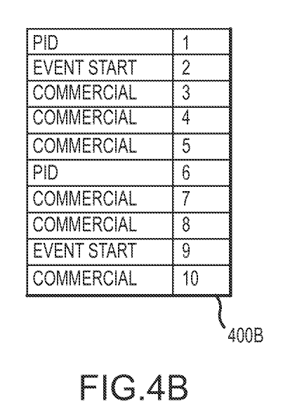

FIG. 4A is a conceptual diagram illustrating a first example bookmark file 400A that may be utilized by the content player 101 of FIG. 1 to process received content. As illustrated, the first example bookmark file 400A contains a bookmark at a location 1 of type PID that includes information specifying which portions of an instance of content at a particular point in the instance of content correspond to video and audio parts of the content; a bookmark at a location 2 of type event start that includes information specifying the start of an event in the instance of content; bookmarks at locations 3, 4, and 5 of type commercial that include information specifying a commercial to play before returning to play additional portions of the instance of content; a bookmark at a location 1 of type PID that includes information specifying which portions of an instance of content at a particular point in the instance of content correspond to video and audio parts of the content; bookmarks at locations 7 and 8 of type commercial that include information specifying a commercial to play before returning to play additional portions of the instance of content; a bookmark at a location 9 of type event start that includes information specifying the start of an event in the instance of content; and a bookmark at a location 10 of type commercial that include information specifying a commercial to play before returning to play additional portions of the instance of content.

FIG. 4B is a conceptual diagram illustrating an index 400B that may be generated for the first example bookmark file 400A of FIG. 4A. As illustrated, the index 400B includes entries that only include the type and location of the respective bookmark corresponding to the entry. A content player such as the content player 101 may utilize the index 400B to search for one or more bookmarks in the bookmark file 400A, as described above.

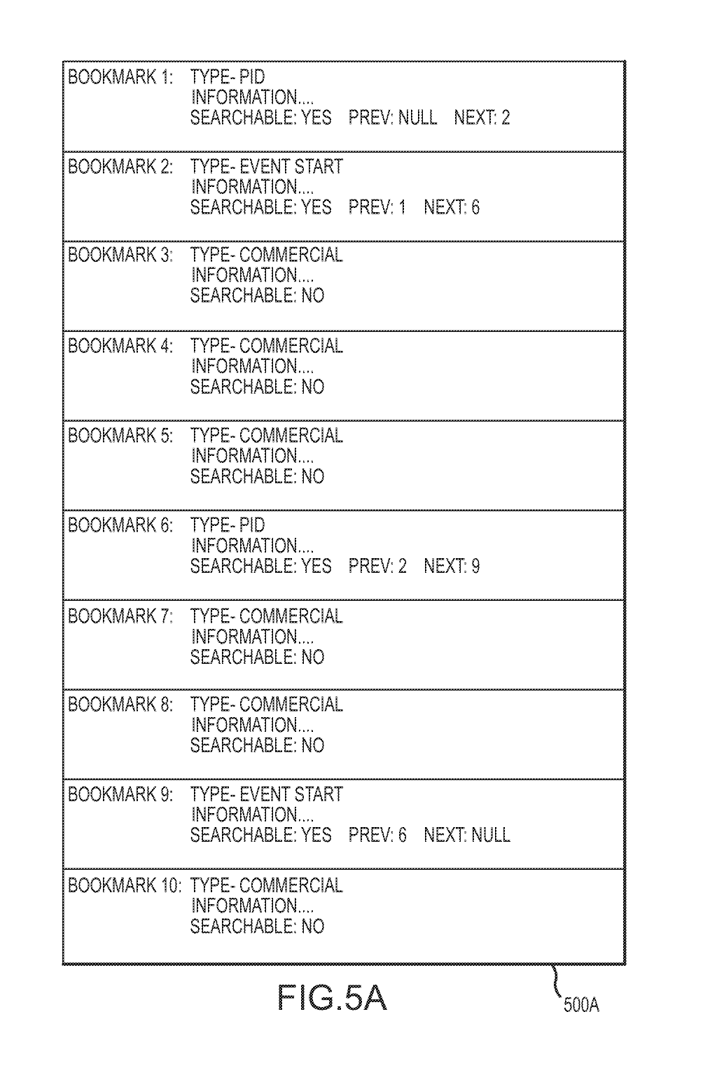

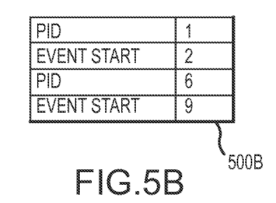

FIG. 5A is a conceptual diagram illustrating a second example bookmark file 500A, which includes one or more bookmarks that are designated as searchable and one or more bookmarks that are designated as non-searchable, that may be utilized by the content player 101 of FIG. 1 to process received content. As illustrated, the second example bookmark file 500A contains bookmarks similar to those illustrated in the first example bookmark file 400A. However, as also illustrated, the bookmark at the locations 3, 4, 5, 7, 8, and 10 include an indication that they are not searchable. Further, the bookmark at locations 1, 2, 6, and 9 include an indication that they are searchable. Additionally, the bookmark at the location 1 includes an indication that there is no previous bookmark in the second example bookmark file 500A as well as a location of the next bookmark in the second example bookmark file 500A, the bookmark at the location 2 includes a location of the previous bookmark in the second example bookmark file 500A (the bookmark at the location 1) and a location of the next bookmark in the second example bookmark file 500A (the bookmark at the location 6), the bookmark at the location 6 includes a location of the previous bookmark in the second example bookmark file 500A (the bookmark at the location 2) and a location of the next bookmark in the second example bookmark file 500A (the bookmark at the location 9), and the bookmark at the location 9 includes a location of the previous bookmark in the second example bookmark file 500A (the bookmark at the location 6) and an indication that there is no next bookmark in the second example bookmark file 500A.

A content player such as the content player 101 may search the second example bookmark file 500A, as described above, by examining only the bookmarks indicated as searchable and ignoring the bookmarks indicated as non-searchable. Further, the content player may locate the first bookmark indicated as searchable (the bookmark at the location 1) when searching and then may continue searching by looking to the location specified for the next searchable bookmark in the file. The content player may utilize the location of the previous bookmark specified by a particular bookmark as well, such as when the content player is searching for an event start bookmark and then needs to find the PID bookmark previous to the event start bookmark in the bookmark file 500A in order to be able to begin playing the event from the content.

If the bookmark file 500A is utilized in an implementation that generates and searches an index of bookmark files, such an index 500B illustrated in FIG. 5B may be generated. As illustrated, the index 500B only includes entries for the bookmarks indicated as searchable in the bookmark file 500A. As illustrated, the index 500B includes entries that only include the type and location of the respective bookmark corresponding to the entry. A content player such as the content player 101 may utilize the index 500B to search for one or more bookmarks in the bookmark file 500A, as described above.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

1. A method for reducing search time of bookmark files that are utilized to process received content, the method comprising:
providing, utilizing at least one content player device, at least one bookmark file wherein the bookmark file comprises a sequential series of bookmarks that each include information utilizable by the at least one content player device to process at least one received content and wherein the bookmark file is generated from metadata corresponding to the at least one received content;
generating, utilizing the at least one content player device, at least one index file for the at least one bookmark file that includes entries that each correspond to at least one bookmark of the sequential series of bookmarks wherein each of the entries includes a type of the at least one bookmark and a location of the at least one bookmark in the at least one bookmark file; and
searching, utilizing the at least one content player device, for a specific bookmark of the sequential series of bookmarks by locating at least one entry in the index file with a type of the specific bookmark and referencing the location included in the at least one entry.

2. The method of claim 1, wherein at least a first bookmark of the sequential series of bookmarks includes an indication that the at least a first bookmark is searchable, at least a second bookmark of the sequential series of bookmarks includes an indication that the at least a second bookmark is not searchable, and the at least one index file includes at least one entry for the at least a first bookmark and does not include an entry for the at least a second bookmark.

3. The method of claim 1, wherein the bookmark file includes at least one of at least one bookmark that specifies a start of an event in the at least one received content, at least one bookmark that specifies a portion of the at least one received content that corresponds to at least one of audio or video, or at least one bookmark that specifies to play content other than the at least one received content.

4. The method of claim 1, wherein the specific bookmark specifies a start of an event in the at least one received content and the method further comprises searching for at least one bookmark that precedes the specific bookmark in the at least one bookmark file and specifies a portion of the at least one received content corresponding to at least one of audio or video.

5. The method of claim 1, further comprising:
determining that the at least one entry does not correspond to the specific bookmark;
locating at least one additional entry in the index file with the type of the specific bookmark; and
referencing the location included in the at least one additional entry.

6. The method of claim 5, wherein said operation of determining that the at least one entry does not correspond to the specific bookmark comprises evaluating the information included in the at least one bookmark in the at least one bookmark file located in the location included in the at least one entry.

7. A method for reducing search time of bookmark files that are utilized to process received content, the method comprising:
providing, utilizing at least one content player device, at least one bookmark file wherein the bookmark file comprises a sequential series of bookmarks that each include information utilizable by the at least one content player device to process at least one received content and wherein the bookmark file is generated from metadata corresponding to the at least one received content;
indicating in the at least one bookmark file, utilizing the a least one content player device, whether each of the sequential series of bookmarks is searchable; and
searching bookmarks of the sequential series of bookmarks that are indicated as searchable, utilizing the at least one content player device, for a specific bookmark.

8. The method of claim 7, wherein at least one bookmark of the sequential series of bookmarks that is indicated as searchable includes at least one location in the at least one bookmark file of at least one of a next searchable bookmark or a previous searchable bookmark.

9. The method of claim 8, wherein said operation of searching bookmarks of the sequential series of bookmarks that are indicated as searchable, utilizing the at least one content player device, for a specific bookmark further comprises:
analyzing the at least one bookmark; and
continuing to search for the specific bookmark based on the at least one location in the at least one bookmark file of the at least one of the next searchable bookmark or the previous searchable bookmark.

10. The method of claim 7, wherein the specific bookmark specifies a start of an event in the at least one received content and the method further comprises searching for at least one bookmark, utilizing at least one location in the at least one bookmark file included in the specific bookmark, that specifies a portion of the at least one received content that corresponds to at least one of audio or video and precedes the specific bookmark in the at least one bookmark file.

11. A system for reducing search time of bookmark files that are utilized to process received content, comprising:
at least one non-transitory storage medium that stores at least one bookmark file wherein:
the bookmark file comprises a sequential series of bookmarks that each include information utilizable to process at least one received content;
the bookmark file is generated from metadata corresponding to the at least one received content; and
each of the sequential series of bookmarks includes an indication that specifies whether the respective bookmark is searchable; and
at least one content player device which utilizes at least one processing unit to search for a specific bookmark of the sequential series of bookmarks by only searching bookmarks that are specified as searchable.

12. The system of claim 11, wherein the specific bookmark specifies a start of an event in the at least one received content and the at least one content player device further utilizes the at least one processing unit to search for at least one bookmark, utilizing at least one location in the at least one bookmark file included in the specific bookmark, that specifies a portion of the at least one received content that corresponds to at least one of audio or video and precedes the specific bookmark in the at least one bookmark file.

13. The system of claim 11, wherein at least one bookmark of the sequential series of bookmarks that is indicated as searchable includes at least one location in the at least one bookmark file of at least one of a next searchable bookmark or a previous searchable bookmark.

14. The system of claim 13, wherein the at least one processing unit analyzes the at least one bookmark as part of searching for the specific bookmark, determines that the at least one bookmark is not the specific bookmark, and continues to search for the specific bookmark based on the at least one location in the at least one bookmark file of the at least one of the next searchable bookmark or the previous searchable bookmark.

15. A system for reducing search time of bookmark files that are utilized to process received content, comprising:
at least one non-transitory storage medium that stores at least one bookmark file wherein the bookmark file comprises a sequential series of bookmarks that each include information utilizable to process at least one received content and wherein the bookmark file is generated from metadata corresponding to the at least one received content;
an index file, stored in the at least one non-transitory storage medium, that includes entries that each correspond to at least one bookmark of the sequential series of bookmarks wherein each of the entries includes a type of the at least one bookmark and a location of the at least one bookmark in the at least one bookmark file; and
at least one content player device which utilizes at least one processing unit to search for a specific bookmark of the sequential series of bookmarks by locating at least one entry in the index file with a type of the specific bookmark and referencing the location included in the at least one entry.

16. The system of claim 15, wherein the at least one processing unit, as part of searching for the specific bookmark, determines that the at least one entry does not correspond to the specific bookmark, locates at least one additional entry in the index file with the type of the specific bookmark, and references the location included in the at least one additional entry.

17. The system of claim 16, wherein the at least one processing unit determines that the at least one entry does not correspond to the specific bookmark by evaluating the information included in the at least one bookmark in the at least one bookmark file located in the location included in the at least one entry.

18. The system of claim 15, wherein the specific bookmark specifies a start of an event in the at least one received content and the at least content player device also utilizes the at least one processing unit to search for at least one bookmark that precedes the specific bookmark in the at least one bookmark file and specifies a portion of the at least one received content corresponding to at least one of audio or video.

19. The system of claim 15, wherein the bookmark file includes at least one of at least one bookmark that specifies a start of an event in the at least one received content, at least one bookmark that specifies a portion of the at least one received content that corresponds to at least one of audio or video, or at least one bookmark that specifies to play content other than the at least one received content.

20. The system of claim 15, wherein at least a first bookmark of the sequential series of bookmarks includes an indication that the at least a first bookmark is searchable, at least a second bookmark of the sequential series of bookmarks includes an indication that the at least a second bookmark is not searchable, and the at least one index file includes at least one entry for the at least a first bookmark and does not include an entry for the at least a second bookmark.
